(19) United States
(12) Patent Application Publication
(10) Pub. No.: US 2015/0104584 A1
(43) Pub. Date: Apr. 16, 2015

(54) METHOD OF INCREASING STRENGTH OF A PANEL EDGE

(71) Applicant: HengHao Technology Co. LTD, Taoyuan County (TW)

(72) Inventors: Ting-Chieh Chen, Taoyuan County (TW); Chin-Liang Chen, Kaohsiung City (TW); Hsiao-Tzu Hsu, Taipei City (TW)

(73) Assignee: HengHao Technology Co. LTD, Taoyuan County (TW)

(21) Appl. No.: 14/071,958

(22) Filed: Nov. 5, 2013

(30) Foreign Application Priority Data
Oct. 15, 2013 (TW) 102137184

(51) Int. Cl. C08J 7/12

(52) U.S. Cl. CPC C08J 7/123
USPC 427/534

(57) ABSTRACT

A method of increasing strength of a panel edge includes providing a panel having a lateral surface treated by plasma. An elastic material is provided, photoinitiator is added therein, and the elastic material is then liquefied by heating. Subsequently, the liquefied elastic material is sprayed on the lateral surface, and is then cured to result in a protective layer bonded on the lateral surface.

### BACKGROUND OF THE INVENTION

1. Field of the Invention

The present invention generally relates to a method of increasing strength of a panel edge, and more particularly to a method of forming a protective layer on a lateral surface of a panel.

2. Description of Related Art

A glass substrate is one of many common elements in a touch module. Sensing electrode layers may be formed on the glass substrate. In manufacturing the touch module, however, defects which are likely to be generated along an edge of the glass substrate may fracture or cause cracks in the glass substrate, thereby affecting functioning of the touch module.

Physical strengthening treatments or chemical strengthening treatments are usually adopted to improve the edge of the glass substrate in order to prevent edge defects. Nevertheless, conventional strengthening treatments may increase manufacturing cost or even raise hazardousness, while having little effectiveness in enhancing protection against impact.

A need has thus arisen to propose a novel method of increasing strength of a glass substrate to effectively protect the glass substrate, ensure functioning of a touch module, and increase yield.

### SUMMARY OF THE INVENTION

In view of the foregoing, it is an object of the embodiment of the present invention to provide a method of increasing strength of a panel edge to form a protective layer on a lateral surface of the panel, thereby effectively increasing strength on the panel edge, preventing defects generated along the panel edge, and maintaining bending strength on the panel edge.

According to one embodiment, a panel having a first surface, a second surface and at least one lateral surface is provided. The first surface is opposite the second surface, and the lateral surface is adjacent between the first surface and the second surface. The lateral surface is treated by plasma. On the other hand, an elastic material is provided, photoinitiator is added in the elastic material, and the elastic material is liquefied by heating. Subsequently, the liquefied elastic material is sprayed on the lateral surface, followed by curing the elastic material to yield a protective layer bonded on the lateral surface.

### BRIEF DESCRIPTION OF THE DRAWINGS

FIG. 1 is a flow diagram illustrating a method of increasing strength of a panel edge according to one embodiment of the present invention;

FIG. 2A shows a top view of a panel;

FIG. 2B shows a lateral view of the panel of FIG. 2A;

FIG. 2C shows a top view of the panel and a protective layer; and

FIG. 2D shows a lateral view of the panel and the protective layer of FIG. 2C.

### DETAILED DESCRIPTION OF THE INVENTION

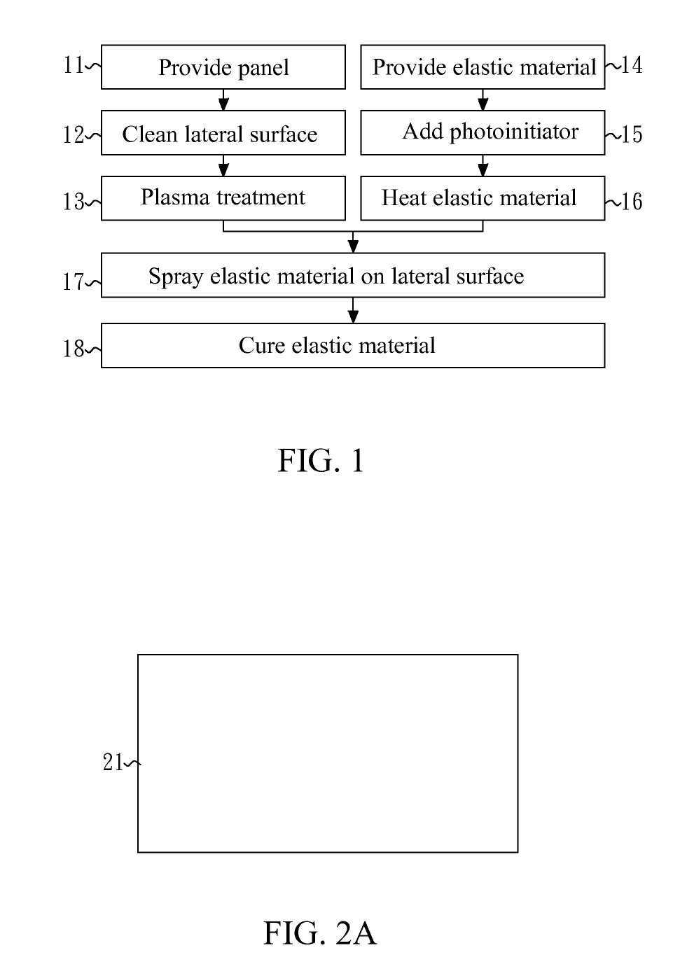

Referring more particularly to the drawings, FIG. 1 shows a flow diagram illustrating a method of increasing strength of a panel edge according to an embodiment of the present invention using a transparent substrate. Although a transparent substrate (such as a glass substrate) of a touch module is exemplified in the embodiment, the embodiment may be well adapted to other (transparent or opaque) panels. Main steps associated with aspects of the embodiment are briefly outlined in FIG. 1, with notation that a person skilled in the pertinent art could add additional steps when needed.

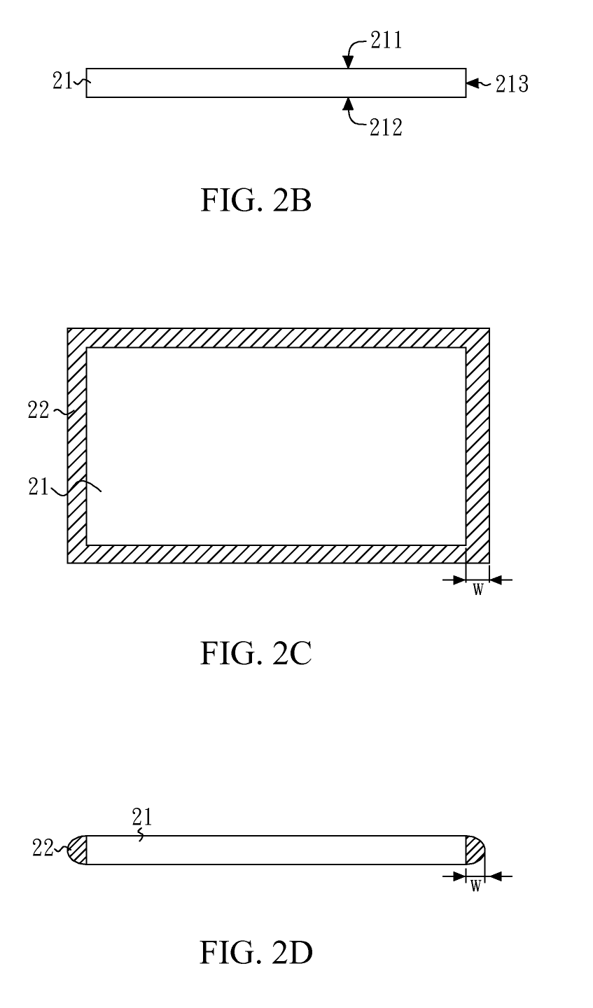

In step 11, a panel 21 (such as a substrate used in a touch module) is provided. FIG. 2A shows a top view of the panel 21, and FIG. 2B shows a lateral view of the panel 21. The panel 21 of the embodiment may, yet not necessarily, be made of a material such as glass, ceramics or their combination. The panel 21 has a first surface 211, a second surface 212 and at least one lateral surface 213. Specifically, the first surface 211 (e.g., a top surface) may be opposite the second surface 212 (e.g., a bottom surface), and the first surface 211 and the second surface 212 define a height therebetween. The panel 21 shown in FIG. 2A/2B has four lateral surfaces 213, which are adjacent between the first surface 211 and the second surface 212. The first surface 211, the second surface 212 and the lateral surface 213 may be either plane or curved surfaces, and may be either smooth or rough. The lateral surface 213 of the panel 21 provided in step 11 may be subjected beforehand to a physical strengthening treatment (such as laser or polishing) or a chemical strengthening treatment (such as Hydrofluoric acid).

Subsequently, in step 12, the lateral surface 213 of the panel 21 may be cleaned in order to remove impurities on the lateral surface 213. In the embodiment, the lateral surface 213 may, but not necessarily, be cleaned by cleaning solution composed of alcohol or ketone (alkanone).

In step 13, the lateral surface 213 of the panel 21 is treated by plasma to activate the lateral surface 213 and to increase hydroxyl (OH) radicals on the lateral surface 213 in order to facilitate bonding between two materials.

On the other hand, steps 14-16 may be executed prior, subsequent or concurring step 11-13. In step 14, an elastic material such as rubber, acrylic resin, polymer or plastic is provided.

Subsequently, in step 15, photoinitiator is added in the provided elastic material. The embodiment adopts ultraviolet (UV) initiator, which helps curing or polymerizing the elastic material, when subject to ultraviolet. Further, the photoinitiator utilized in the step may enhance reaction with the aforementioned hydroxyl (OH) radicals to increase adhesion.

In step 16, the elastic material is liquefied by heating to shorten molecular bond and weaken bonding strength of the elastic material. According to one aspect of the embodiment, the heated elastic material may have a viscosity of less than 300 Centiposes (cps). The heating temperature and duration depend on softening or melting temperature of the employed elastic material. The elastic material may be heated in an electrical heating scheme such as plasma heating or arc heating; or in a chemical heating scheme such as combustion heating.

Subsequently, in step 17, the liquefied elastic material is thermally sprayed and coated on the lateral surface 213 of the panel 21, therefore forming a protective layer 22 on the lateral surface 213, as shown in a top view of FIG. 2C and in a lateral view of FIG. 2D. In the embodiment, the protective layer 22 may have a width w of about 60-100 μm. It is appreciated that a single instrument may be utilized to simultaneously perform heating process (step 16) and spraying process (step 17). That is, the instrument may spray liquefied elastic material on the lateral surface 213 of the panel 21 while heating the elastic material. The thermal spraying process adopted in the embodiment may effectively control the coated width of the protective layer 22, and may effectively cause the elastic material to go deep into minute slits on the lateral surface 213. Therefore, bonding between the elastic material and the lateral surface 213 of the panel 21 may be greatly enhanced to increase adhesion.

After liquefied elastic material is sprayed on the lateral surface 213 of the panel 21, the liquefied elastic material may be half cured by being subjected to room temperature or reduced temperature for a predefined period. Afterwards, in step 18, the protective layer 22 may be completely cured by irradiating ultraviolet.

According to the steps performed as described above, the protective layer 22 may have a hardness up to Shore D50±5. Further, the protective layer 22 bonded on the lateral surface 213 of a glass panel 21 may have an adhesion greater than 4B in ASTM (American Society for Testing and Materials)-D3359 standard. The protective layer 22 of the embodiment may be adapted to a touch module with a transparent substrate having a dielectric coefficient less than 3.7 (in 50 Hz).

Accordingly, the embodiment may effectively increase strength on an edge of the panel 21, may prevent defects generated along the edge of the panel 21, and may maintain bending strength on the edge. According to the embodiment, the panel 21 may be effectively protected during an impact test, for example, in which a 1-kg steel ball falls from 20 cm height onto the edge of the panel 21 and finds no damage to the panel 21.

Although specific embodiments have been illustrated and described, it will be appreciated by those skilled in the art that various modifications may be made without departing from the scope of the present invention, which is intended to be limited solely by the appended claims.

What is claimed is:

1. A method of increasing strength of a panel, comprising:
providing a panel having a first surface, a second surface and at least one lateral surface, the first surface being opposite the second surface, and the lateral surface being adjacent between the first surface and the second surface;
treating the lateral surface by plasma;
providing an elastic material;
adding photoinitiator in the elastic material;
liquefying the elastic material by heating;
spraying the liquefied elastic material on the lateral surface; and
curing the elastic material to result in a protective layer bonded on the lateral surface.

2. The method of claim 1, wherein the panel comprises glass, ceramics or their combination.

3. The method of claim 1, wherein the panel constitutes a transparent substrate of a touch module.

4. The method of claim 1, prior plasma treatment, further comprising a step of cleaning the lateral surface of the panel to remove impurities on the lateral surface.

5. The method of claim 4, wherein the cleaning step comprises using cleaning solution composed of alcohol or ketone to clean the lateral surface.

6. The method of claim 4, prior cleaning step, further comprising a step of subjecting the lateral surface to a physical strengthening treatment or a chemical strengthening treatment.

7. The method of claim 1, wherein the elastic material comprises rubber, acrylic resin, polymer or plastic.

8. The method of claim 1, wherein the photoinitiator comprises ultraviolet (UV) initiator.

9. The method of claim 1, wherein the heated elastic material has a viscosity of less than 300 Centiposes (cps).

10. The method of claim 1, wherein the elastic material is heated in an electrical or a chemical heating scheme.

11. The method of claim 1, wherein the protective layer has a width of about 60-100 μm.

12. The method of claim 1, wherein the elastic material is cured by irradiating ultraviolet onto the elastic material.

13. The method of claim 1, wherein the protective layer has a hardness of Shore D50±5.

14. The method of claim 1, wherein the protective layer bonded on the lateral surface of the panel has an adhesion greater than 4B in ASTM (American Society for Testing and Materials)-D3359 standard.

15. The method of claim 1, wherein the protective layer has a dielectric coefficient less than 3.7.
